(19) United States
(12) Patent Application Publication
(10) Pub. No.: US 2020/0134522 A1
(43) Pub. Date: Apr. 30, 2020

(54) METHOD AND SYSTEM FOR CARGO MANAGEMENT

(71) Applicant: TRUENORTH SYSTEMS LTD, Tel Aviv (IL)

(72) Inventors: Shlomo LAHAV, Ramat-Gan (IL); Efrat Ben-Ami, Tel Aviv (IL)

(73) Assignee: TRUENORTH SYSTEMS LTD, Tel Aviv (IL)

(21) Appl. No.: 16/658,151

(22) Filed: Oct. 20, 2019

Related U.S. Application Data
(60) Provisional application No. 62/751,858, filed on Oct. 29, 2018.
(60) Provisional application No. 62/788,937, filed on Jan. 6, 2019.

(51) Int. Cl. G06Q 10/06; G06Q 10/04; G06Q 10/08; H04W 4/021; G06Q 50/28

(52) U.S. Cl. CPC G06Q 10/0635; G06Q 10/047; G06Q 50/28; G06Q 10/0831; H04W 4/021; G06Q 10/0833

(57) ABSTRACT

A cargo management system for handling cargo transportation is disclosed. The management system can be configured to determine the risk that is involved in a journey of a cargo-shipping-unit (CSU). The system comprises a Risk-Analyzer-Unit (RAU). The RAU can be configured to obtain one or more features of the journey of that CSU. Next the RAU can fetch a predictive model that can predict the likelihood that a demand for loss (DFL) will be filed. In addition the RAU can be configured to present the likelihood that a demand DFL will be filed as the risk that is associated with that journey of that CSU.

### CROSS-REFERENCE TO RELATED APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Oct. 29, 2018 and assigned the Ser. No. 62/751,858, which application is herein incorporated by reference in its entirety; and the United States provisional application for patent that was filed on Jan. 06, 2019 and assigned the Ser. No. 62/788,937, which application is herein incorporated by reference in its entirety.

### FIELD OF THE DISCLOSURE

The present disclosure relates to the field of cargo transportation and more particularly to cargo management system that is related to demand for damages that were filed. The term “demand for loss/damage” refers hereinafter to a loss submission/notification filed by a cargo owner (or a party with any interest in the transported cargo) against a third party linked to the transporting process, and which might potentially bears liability for any losses or damages inflicted to the cargo during transit. Such third party could be an insurance company, a carrier, or any other third party involved in the transporting process.

Generally the term “claim for alleged loss” is used instead of the term “demand for loss/damage” however in order to distinguish this type of claim from a “claim” as is used in the context of patent submissions, we will refer to “claim for alleged loss” henceforth as a “demand for loss” (DFL).

### DESCRIPTION OF BACKGROUND ART

Common cargo transportation is implemented by a shipping unit. An example of a cargo shipping unit (CSU) can be a container, an air parcel, etc. A common CSU provides an enclosed space in which physical items can be stored during shipment. A single journey of a CSU can comprise a plurality of segments. In each segment a different entity can be responsible for the safety of the CSU and its cargo.

An example of a journey of a CSU from an origin (such as but not limited to a factory, a warehouse, a retail outlet, etc.) to a destination (such as but not limited to a warehouse, a retail outlet, a customer premises, etc.) can comprise a plurality of segments. Segments such as but not limited to: loading the goods into the CSU at the shipper's platform; loading the CSU on a vehicle such as but not limited to a truck or a train at the shipper's yard; transporting the CSU toward the port or the airport; off-loading the CSU from the truck or the train; storing the CSU at the port or airport; embarking the CSU on the ship or airplane; transporting the CSU by the ship or the airplane; off-loading the CSU from the ship or airplane; temporary storing the CSU in the port (airport); loading the CSU on a truck or a train; transporting the CSU toward the consignee's yard; and off-loading the CSU from the truck to the consignee's platform. Along the disclosure and the claims the terms origin, shipper and supplier can be used interchangeably and the terms destination, consignee, supplier's customer, or customer can be used interchangeably. Along the disclosure and the claims the terms a vehicle, a truck, a train, a ship, an airplane, etc. can be used interchangeably.

A person with ordinary skill in the art of cargo transportation can appreciate that some journeys may comprise all the above segments; other journeys may comprise part of those segments; and some journeys may comprise more segments than the ones that are disclosed above. Yet in some journeys the order of the segments can be other than the above disclosed order. It should be noted that the disclosed segments of a journey are not intended to limit the scope of the inventive concepts in any manner.

There are journeys in which different entities are responsible for the safety of the cargo. Each entity can be responsible for one or more segments of a journey. A truck company can be responsible for losses that occur during traveling by a truck. A sea carrier can be responsible for loading the cargo on the ship, losses that occur during the ship traveling or when off-loading the CSU from the ship, etc. Thus, in case of demand for loss it can be essential, for some of the involved parties, to point on one or more segments in which the loss occurred.

In order to support demands for losses a plurality of sensors may be added to a CSU. Some of the sensors may be configured to monitor: acceleration, shocks, pressure, temperature, light, humidity, tilt, time. Other sensors can be microphones, magnetic sensors at the doors, etc. Some of the sensors can be sensitive to two or more parameters. An example of such a combined sensor can be “MultiSensor 6”. “MultiSensor 6” can deliver information regarding motion, temperature, humidity, light, vibrations, and ultraviolet light (UV) as well as wireless communication based on Z-Wave protocol.“MultiSensor 6” is a trade name of Aeotec Inc USA. Z-Wave protocol is well known to a person with ordinary skill in the art and will not be further disclosed.

The readings of those sensors can be used for determining whether the demand for loss is a valid one or not. Further, the readings of those sensors can be used for determining in which segment the loss occurred and which party might be responsible for the loss.

Usually a surveyor can evaluate the loss but cannot point on the location and the time that the loss occurred. A typical surveyor's report can indicate whether the demand for loss is a valid demand and the value of the loss or damage. Along the present disclosure and the claims the terms loss or damage can be used interchangeably.

### BRIEF SUMMARY

The needs and the deficiencies, which are disclosed above in relation to filed demands for loss, are not intended to limit the scope of the inventive concepts of the present disclosure in any manner. The needs are presented for illustration only.

Example embodiments of the disclosed technique seek to provide a novel technique for handling demands for losses that occur along a journey of a CSU. A demand for loss can be analyzed in view of relevant information that is stored in one or more databases. Information such as but not limited to information that is related to similar journeys, similar CSUs, similar goods, similar period of the year, etc.

An example embodiment of the disclosed technique may comprise a demand-for-loss-receiving unit (DFLRU), a Demand-For-Loss-analyzer unit (DFLAU), operational-recommending-unit (ORU), a predicting-model generator (PMG), a risk analyzing unit (RAU) and one or more databases.

An example embodiment of the disclosed technique may be associated with one or more external databases that store general information, which is related to cargo transportation. For convenience and clarity of presentation the present disclosure refers to a plurality of databases, each database can be associated with one or more types of information. However, a person with ordinary skill in the art can appreciate that two or more of those databases may be embodied on one or more physical or virtual media. Such media includes, but not limited to, a read/write hard disc, CDROM, Flash memory, ROM, or other memory or storage devices. In some embodiments, one or more DBs can reside over the Internet cloud.

Some examples embodiments of the disclosed technique may communicate with external databases. Databases such as but not limited to: one or more databases (DB) of journeys, one or more DBs of CSUs, one or more DBs of types of cargo, one or more DBs of sensors, one or more DBs that contain weather information, etc. In some embodiments, one or more DBs can reside over the Internet cloud.

Each entry in an example of journey DB can be associated with a course from a shipper to a consignee. In some cases the shipper and/or the consignee premises can be substituted with an appropriate street, city, district, state, etc. depending on the resolution of the current stored data in the journey DB. Some embodiments of the disclosed technique can be configured to improve the resolution of the stored data at the end of each journey. Each course can comprise a plurality of segments. Each segment can be associated with one or more possible carriers.

An example of CSU DB may store information about features of a plurality of CSUs. Each entry of the CSU DB can be associated with a certain type of CSU. The stored features of each CSU can comprise the material from which the CSU is made, the dimension of the CSU, whether the CSU includes environmental control devices, which sensors are associated with the CSU, whether the CSU is sealed to liquid and/or gas, previous damages, etc.

Each entry in an example of cargo DB may store features of a certain type of cargo. Features such as but not limited to cost, sensitivity to shocks, sensitivity to temperature, sensitivity to humidity, sensitivity to water, does it carry liquid, is the cargo explosive, etc.

Each entry in an example of sensors DB can be associated with a type or a model of a sensor and may comprise the one or more parameters that are measured by the sensor (shock, humidity, temperature, etc.), the sensitivity of the sensor, the range that the sensor can measure, the tolerance of the readings, the sensors' firmware and hardware versions, etc.

An example of weather DB may store information about the weather according to location, and time. The resolution of the time can be seasons, months, day or even hours.

Some embodiments of the disclosed technique can be configured to update the stored data or to improve the resolution of the stored data in one or more of the DBs. Other embodiments of the disclosed technique can be configured to update the stored data in the DBs or to improve the resolution of the stored data during a current journey.

In addition to the one or more external databases, some embodiments of the disclosed technique may comprise internal DBs. The internal DBs may store proprietary information. The proprietary information may comprise historical information. Each entry in the historical DB (HDB) can comprise information related to a journey, information related to the cargo, information related to the type of the CSU, etc. In addition, the entry may store an indication whether a demand for loss was filed or not. If a demand for loss was filed, the related stored information may comprise the type of the damage, the reading of the sensors, etc. In addition, an indication whether the DFL was approved, by a human-surveyor, or not can be stored too.

An example of demand-for-loss-receiving unit (DFLRU) can comprise one or more processors that are embedded in one or more computers. The computer can be Intel NUC, wherein NUC stands for Next-Unit-of-Computing. Other embodiments may use computers such as “Amazon EC2 A1 Instances” or “Amazon EC2 P3 Instances”, which are maintained by Amazon Crop USA. Yet, some embodiments of the disclosed technique may use computers such as “General purpose machine type family N1” which is maintained by Google, USA. An example DFLRU can be configured to obtain DFLs forms in one or more formats, one or more units, etc. The obtained forms can be converted to a standard format in order to generate a standardized-Demand-for-loss-report (SDFLR). Next the DFLRU may deliver the generated SDFLR to the DFLAU.

In some embodiments the DFLRU can be configured to communicate with a person that currently prepares a demand for loss. In such embodiment the DFLRU can be configured to lead the requesting person along the process of filling the one or more forms of the demand for loss.

An example of DFLAU can be a high-end computer that is configured to execute one or more machine learning programs (MLP) in order to learn which recommending report to deliver per a certain DFL. A non-limiting example of a powerful computer can be “Amazon EC2 P3 Instances” maintained by Amazon Corp or “General purpose machine type family N1” which is maintained by Google, USA, etc. A non-limiting example of an MLP can be based on “TensorFlow” maintained by Google Brain Team USA, etc.

Other embodiments of the disclosed technique may use predictive algorithm such as but not limited to logistic regression, linear regression, decision tree, random-forest, etc. in order to generate a predictive function that can be used to predict the probability that damage may occur in a certain journey. In such embodiment the DFLAU can be configured to calculate the predicted probability for damage and compare it to a certain threshold. If the value of the predicted probability is higher than the threshold, then the demand for loss can be marked as demand for occurred damages (a valid DFL) otherwise the demand for loss can be marked a suspected DFL. Some embodiment of the disclosed technique may select the value of the threshold from a range of 30% to 60%. An example value of the threshold can be 50% probability that the relevant damage may occur. Along the disclosure and the claims the terms “a valid DFL”, “a justified DFL” and “demand for occurred damages” can be used interchangeably.

From time to time, every few weeks, one to ten weeks for example, an example of DFLAU can be configured to activate a machine-learning program (MLP) in order to scan the stored data in the historical database and to deliver an updated predicting model. The updated predicting model can predict the probability that a certain demand for loss is a valid DFL. This recommendation can be added to the demand for loss before transferring the demand for loss to a human surveyor to be used as an additional tool while preparing his report. Some example embodiment of the disclosed technique may use a classifier model instead of a predicting model. Along the present disclosure the claims the terms predicting model and classifier model can be used interchangeably.

Some example embodiments of the disclosed technique may be configured to deliver operational recommendations based on the data that is stored in the history DB. Such embodiments may comprise an ORU. A shipper or a carrier that needs to deliver a certain cargo from point A to point B may load to the ORU information regarding the type of the cargo, the location of the origin and the destination, the requested date, requested cost, etc. The ORU may process the information in view of similar journeys that are stored in the history DB and may deliver recommendation how to deliver the relevant cargo with a minimum risk for damage. Some embodiment may estimate also the duration of a journey along a recommended path. The recommendations can refer to the type of CSU, the route of the journey, recommended carriers, ports, etc.

Some example embodiments of the disclosed technique may be configured to process the stored data in the history DB and deliver a risk model. In such embodiments a risk analyzer unit (RAU) can associate a risk factor to one or more carriers, one or more types of CSUs, one or more segments, etc. At the end of processing the relevant information from the historical DB, an example of a RAU can estimate the probability for damage along a certain journey. Based on the risk report a shipper or a carrier can determine which routes to select, which carrier, etc. Along the present disclosure and the claims the terms route of a journey and a plan of a journey can be used interchangeably.

An example of predicting-model generator (PMG) can operate in two modes of operation, learning mode and ongoing mode. The learning mode can be executed after the initialization of the PMG and when the historical DB contains sufficient data to enable the MLP to start preparing a predictive model. During the learning mode new predictive models can be produced. The ongoing mode can be executed after the learning mode while using the generated predictive models. During the ongoing mode an example of PMG can be configured to monitor and to tune one or more existing predictive models.

During the learning mode a number of journeys can be sampled by the PMG in order to define new predictive models. During the ongoing mode the predictive model can be updated.

The foregoing summary is not intended to summarize each potential embodiment or every aspect of the present disclosure, and other features and advantages of the present disclosure will become apparent upon reading the following detailed description of example embodiments with the accompanying drawings and appended claims.

Furthermore, although specific example embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the disclosed embodiments with the accompanying drawings and appended claims.

### BRIEF DESCRIPTION OF THE DRAWINGS

Exemplary embodiments of the present disclosure will be understood and appreciated more fully from the following detailed description, taken in conjunction with the drawings in which:

FIG. 1 illustrates a simplified block diagram with relevant elements of an example of a cargo management system that operates according to the disclosed technique;

FIG. 2 schematically illustrates a flowchart showing relevant processes that can be implemented for collecting data to be stored in a historical database;

FIG. 3 schematically illustrates a flowchart showing relevant processes that can be implemented by an example predicting-model generator (PMG) for generating a predicting model that can predict whether a demand for damage will be filed;

FIG. 4A schematically illustrates a flowchart showing relevant processes that can be implemented by an example of DFLAU for analyzing whether a DFL is valid and indicating on one or more suspected segments of the journey in which the damage might happened;

FIG. 4B schematically illustrates a flowchart showing relevant processes that can be implemented by an example of DFLAU for defining one or more causes for the damage related to a valid DFL;

FIG. 4C schematically illustrates a flowchart showing relevant processes of another method that can be implemented by an example of DFLAU for defining one or more causes for the damage related to a valid DFL.

FIG. 5A schematically illustrates a flowchart showing relevant processes that can be implemented by an example of operational-recommending-unit (ORU) for calculating the impact of each Parameter of Interest (POI) between an origin and a destination of a certain journey;

FIG. 5B schematically illustrates a flowchart showing relevant processes that can be implemented by an example of operational-recommending-unit (ORU) for recommending how to handle a certain cargo independently of the route;

FIG. 6 schematically illustrates a flowchart showing relevant processes that can be implemented by an example ORU for supporting a decision maker to select a certain plan of a journey according to his preferences; and

FIG. 7 schematically illustrates a flowchart showing relevant processes that can be implemented by an example method for determining the risk that is associated with a certain cargo in a certain journey.

### DETAILED DESCRIPTION OF EXEMPLARY EMBODIMENTS

The disclosed technique can be implemented in numerous ways, including as a process; an apparatus; a system; a computer program product embodied on a computer readable storage medium; and/or a processor, such as a processor configured to execute instructions stored on and/or provided by a memory device coupled to the processor.

In this specification, these implementations, or any other form that the invention may take, may be referred to as techniques. In general, the order of the steps of disclosed processes may be altered within the scope of the invention. Unless stated otherwise, a component such as a processor or a memory device described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module.

Additionally, multiple modules of the same or different types may be implemented by a single processor. Software of a logical module may be embodied on a computer readable device such as a read/write hard disc, CDROM, Flash memory, ROM, or other memory or storage devices, etc. In order to execute a certain task a software program may be loaded to an appropriate processor as needed. In the present disclosure the terms task, method, process can be used interchangeably. In the present disclosure the verbs transmit, transfer or be placed in a queue can be used interchangeably.

Turning now to the figures in which like numerals represent like elements. The purpose of the drawings is to describe example embodiments and not for production. Therefore features shown in the figures are chosen for convenience and clarity of presentation only. Moreover, the language used in this disclosure has been principally selected for readability and instructional purposes, and may not have been selected to delineate or circumscribe the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware.

Additionally, multiple modules of the same or different types may be implemented by a single processor. Software of a logical module may be embodied on a computer readable memory device such as a read/write hard disc, CDROM, Flash memory, ROM, or other memory devices or storage devices, etc. In order to execute a certain task a software program may be loaded to an appropriate processor as needed. In the present disclosure the terms task, method, and process can be used interchangeably.

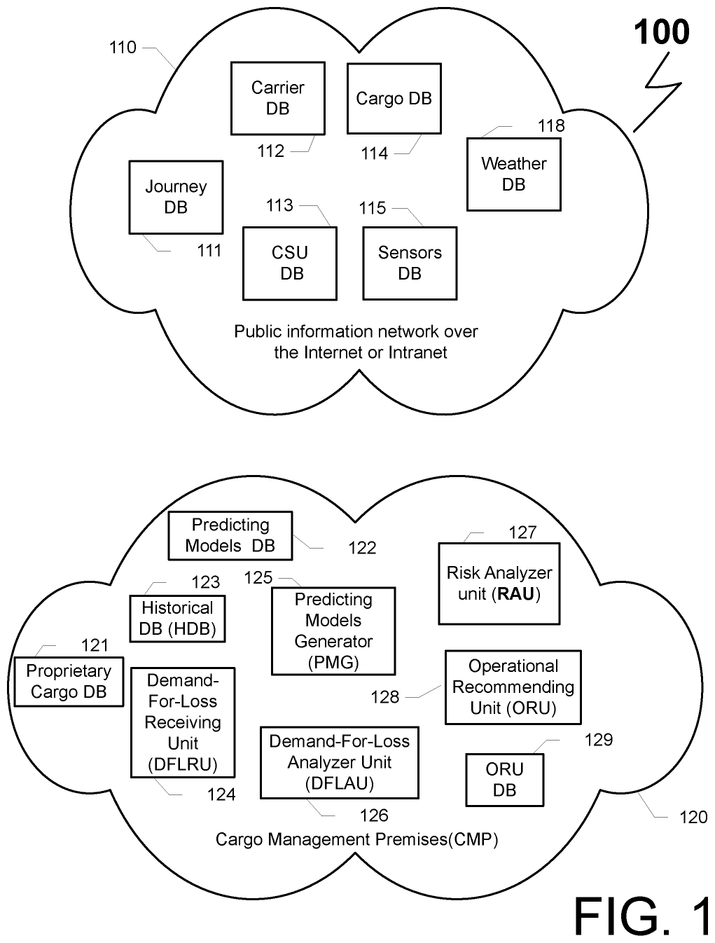

FIG. 1 depicts a simplified block diagram with relevant elements of an example of a cargo management system (CMS) 100 that operates according to an example embodiment of the disclosed technique. An example of CMS 100 may comprise a public information network 110 and a proprietary information network 120. The public information network 110 can reside over the Internet, or over a plurality of Intranets (domains) of different entities. The different entities may comprise entities that deliver containers, shipping services, etc.

An example of public information network 110 can comprise a journey DB 111, a carrier DB 112, a CSU DB 113, a cargo DB 114, a sensors DB 115 and weather DB 118. Other example of public information network 110 may comprise part of those DBs or additional DBs, such as but not limited to a shipper's DB (not shown in the figures). The shipper DB may store information related to a certain shipper. Information such as location, type of vehicle, previous demands for loss, payment history, loading platform properties, etc.

Each entry in an example of journey DB 111 can be associated with a course from a shipper to a consignee. In some cases, the shipper and/or the consignee premises can be substituted with an appropriate street, city, district, state, etc. depending on the resolution of the current stored data in the DBs. Some embodiments of the disclosed technique can be configured to improve the resolution of the stored data at the end of each journey.

Each course can comprise a plurality of segments. Each segment can be associated with one or more possible carriers. Further, per each segment indication can be added about the history of demands for loss that were filed and are related to a certain course or a certain segment. The percentages of the DFL that were marked as valid DFL. Thus, analyzing the data that is stored in the journey DB 111 may provide insights about the risk that can be associated with a certain course or a segment.

An example of carrier DB 112 may comprise information related to a plurality of carriers. Each entry in the carrier DB 112 may comprise information related to a certain carrier. The carrier can be a sea-carrier, an air-carrier, a train company, a truck company, etc. The information may comprise sizes limitations of CSUs that can be handled by that carrier, weight limitations, scheduling information, possible routes, history of demands for loss that were filed against this carrier and whether the demands were approved or not, etc.

CSU DB 113 may store information about a plurality of types of CSUs. Each entry in an example of CSU DB 113 may store information about features of a certain type of CSU. The information may comprise features such as but not limited to the material from which the CSU is made, the dimension of the CSU, whether the CSU includes climate control devices, which sensors are associated with the CSU, whether the CSU is sealed to liquid and/or gas, previous damages, historical filed DFLs that are related to that CSU, etc.

Cargo DB 114 may store information related to a plurality of types of cargo. Each entry in an example of cargo DB 114 may store features of a certain type of cargo. Features such as but not limited to cost, sensitivity to shocks, sensitivity to vibrations (amplitude and frequency), sensitivity to temperature, sensitivity to humidity, sensitivity to water, does it carry liquid, is the cargo explosive, etc. In addition, cargo DB 114 may store information regarding the packaging of the cargo, is it boxes with the dimension and weight of each box. Is the cargo powder inserted in sacks, etc.

Sensors DB 115 may store information related to a plurality of types of sensors. Each entry in an example of sensors DB 115 can be associated with a type or a model of a sensor and may comprise the one or more parameters that are measured by the sensor (shock, humidity, temperature, etc.), the sensitivity of the sensor, the range that the sensor can measure, the tolerance of the readings, the sensor hardware version, and the sensor software version, etc.

Weather DB 118 may store information related to the weather in a plurality of locations and routes as well as in a plurality of periods of the year. An example of DB 118 can be arranged as a two-dimensional matrix. The first axis can be associated with a location, a segment along a certain route, etc. The second axis can associate with the month. Each cell, at a junction of a certain location and a certain month, may include information regarding the weather, the lighting hours, the probability for a storm, etc. Other example embodiments of DB 118 may use other resolution per one or more axis of the matrix. In other examples the resolution of the time axis can be expressed in days and not in months, etc.

Referring now to the Cargo-Management-Premises (CMP) 120. CMP 120 can be a private domain of an insurance company or a private domain of a certain shipper, etc. An example of CMP 120 may comprise one or more private DBs and one or more processing devices. An example of CMP 120 may comprise: Proprietary-cargo DB 121, Predicting models DB 122, historical DB (HDB) 123, and operational-recommending-unit (ORU) DB 129. In addition, an example of CMP 120 may comprise few examples of processing devices, devices such as but not limited to: Demand-For-Loss-receiving unit (DFLRU) 124, Predicting-models generator (PMG) 125, Demand-For-Loss-Analyzer unit (DFLAU) 126, Risk-analyzer unit (RAU) 127, and Operational-recommending unit (ORU) 128.

An example of the Proprietary-cargo DB 121 may store proprietary information regarding types of cargo. Each entry in an example of DB 121 may store features of a certain type of cargo. Features such as but not limited to cost, sensitivity to shocks, sensitivity to vibrations (amplitude and frequency), sensitivity to temperature, sensitivity to humidity, sensitivity to water, does it carry liquid, is the cargo explosive, etc. In addition, each entry may comprise proprietary information which is related to DFLs that were filed in relation to the relevant type of cargo. Information such as but not limited to how many DFLs were filed for this type of cargo, the percentage of journeys in which a DFL was filed related to this type of cargo, etc.

The historical DB (HDB) 123 may store information that was gathered during the years of operational of the owner of the domain 120. The HDB 123 can be used for building predicting models that can predict the probability for a demand for loss along a certain journey. Each entry in the HDB 123 can comprise information related to a journey from an origin to a destination, information related to the type of cargo and the target features of that cargo, information related to the type of the CSUs, information regarding the segments of the relevant journey, information regarding different carriers that can be used along the journey, information regarding the vehicle that is used, etc.

In addition, each entry in HDB 123 may store indication whether a demand for loss was filed. If a demand for loss was filed, then the related stored information may comprise the type of the damage, the reading of the sensors, etc. In addition, an indication whether a human surveyor found the demand for loss as a valid demand and what is the relevant value of the loss or damage.

Periodically, the HDB 123 can be updated with information that was gathered during the current period of time. Further, the information that is stored in the HDB 123 can be used for producing or updating one or more predicting models that can predict the probability that a demand for damages will be filed in a future similar or relevant journey. Along the disclosure and the claims the terms similar or relevant can be used interchangeably.

An example of predicting-models-DB 122 may store a plurality of predicting models that were produced by PMG 125. Each predicting model can be used for calculating the probability for damage along a certain journey. The parameters that can be used in a predicting model can refer to the type of cargo, the type of CSU, the carrier, the course, segments in the course, the date, etc. The stored predicting models can be used by one or more of the processing units of CMP 120.

An example of ORU DB 129 may store a plurality of operational recommendations to be used by the owner of the CMP 120 or any authorized party. Each entry in the ORU DB 129 may store recommendation that can be used for planning a certain journey of a certain type of cargo. The recommendation can point on a certain carrier, a certain route from the origin to destination, the predicted duration of each route, a recommended location on the ship, recommended price for such combination of routes, carrier and cargo type, etc.

An example of Demand-For-Loss-receiving unit (DFLRU) 124 can comprise one or more processors that are embedded in one or more computers. The computer can be Intel NUC, wherein NUC stands for Next-Unit-of-Computing. Other embodiments of the disclosed technique may use computers such as “Amazon EC2 A1 Instances” or “Amazon EC2 P3 Instances”, which are maintained by Amazon Crop USA. Yet, other example embodiments may use computers such as “General purpose machine type family N1” which is maintained by Google, USA, etc.

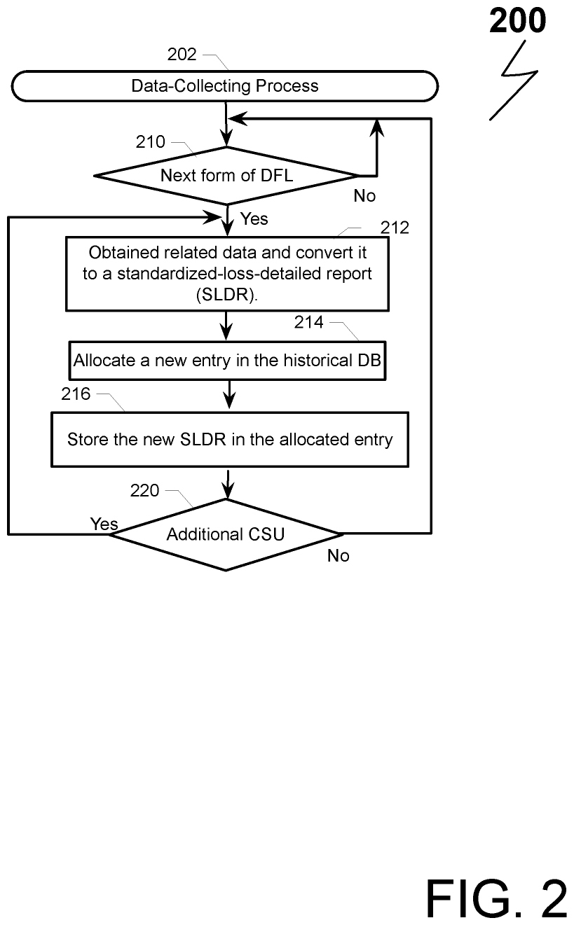

An example DFLRU 124 may be configured to obtain DFLs submission in one or more formats, one or more units (kilogram, tons, pound, dollars, yen, kilometer, mile) etc. The obtained submissions can be converted to a standard format in order to produce a standardized-demand-for-loss-report (SDFLR). Next the DFLRU 124 may deliver SDFLR to a queue of the DFLAU 126. More information regarding an example process for data collecting by an example of DFLRU 124 is disclosed below in conjunction with FIG. 2

From time to time, every few weeks one to ten weeks for example, an example of PMG 125 can be configured to activate a machine-learning program (MLP) in order to scan the stored data in the HDB 123 and to deliver an updated predicting model to be stored in the predicting models DB 122. The updated predicting model can predict the probability that a filed DFL is for damage that actually occurred.

An example of predicting-model generator (PMG) 125 can operate in two modes of operation, learning mode and ongoing mode. The learning mode can be executed after the initialization of the PMG 125 and when the HDB 123 contains sufficient data to enable an example of an MLP to start preparing a predicting model for a certain journey and a certain type of cargo. Example embodiments of PMG 125 may use predictive algorithm such as but not limited to logistic regression, linear regression, decision tree, random-forest, etc. in order to create a predictive function that can be used to predict the probability that damage will occur in a certain journey. More information regarding the operation of PMG 125 is disclosed below in conjunction with FIG.

The ongoing mode of PMG 125 can be executed after the learning mode and may monitor and fine-tune one or more existing predictive models that are stored in predicting model DB 122. An example of PMG 125 can be implemented by a processing unit such as Intel NUC, or “Amazon EC2 A1 Instances” or “Amazon EC2 P3 Instances”, etc.

An example of DFLAU 126 can be implemented by a processing unit. The processing unit may comprise one or more high-end computers, such as but not limited to “Amazon EC2 A1 Instances” or “Amazon EC2 P3 Instances”, which are maintained by Amazon Crop USA, for example. Other embodiments of DFLAU 126 may comprise computers such as but not limited to “General purpose machine type family N1” which is maintained by Google, USA, etc. An example of DFLAU 126 may be configured to execute one or more MLPs for analyzing standardized-demand-for-loss report (SDFLR), obtained from the DFLRU 124, and recommending whether the demand for loss is valid or not. Some embodiments of DFLAU 126 may recommend also the value of the loss. A non-limiting example of a MLP can be based on “TensorFlow” maintained by Google Brain Team USA, etc.

In some embodiments the DFLAU 126 can be configured to scan the predicting models DB 122 looking for a valid predicting model that can apply to a current case. If a valid model does not exist, then the DFLAU 126 may request the PMG 125 to prepare such a predictive model.

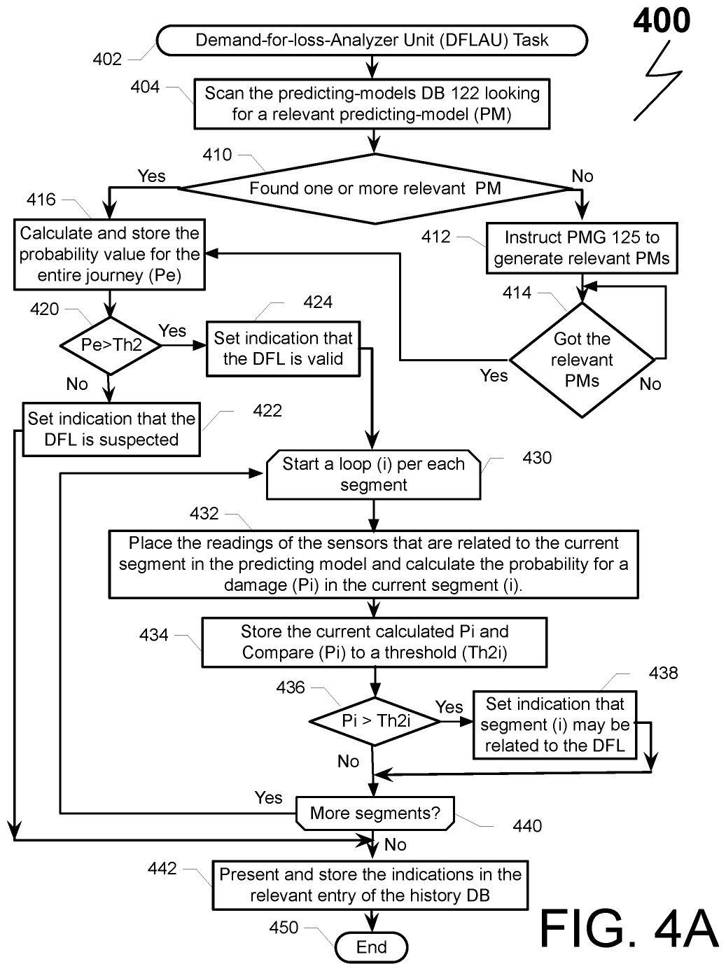

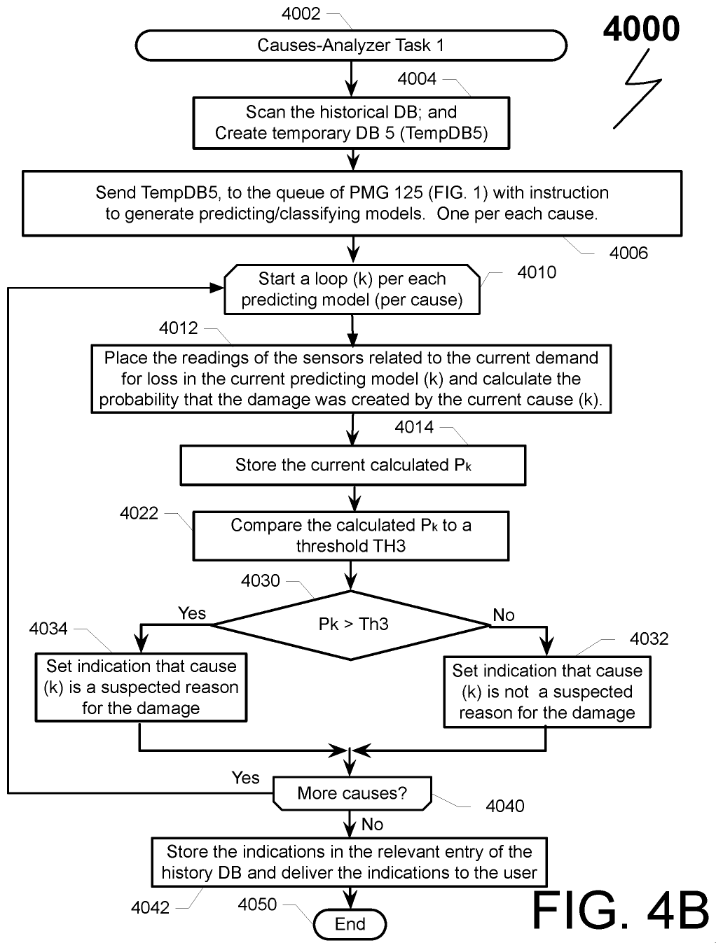

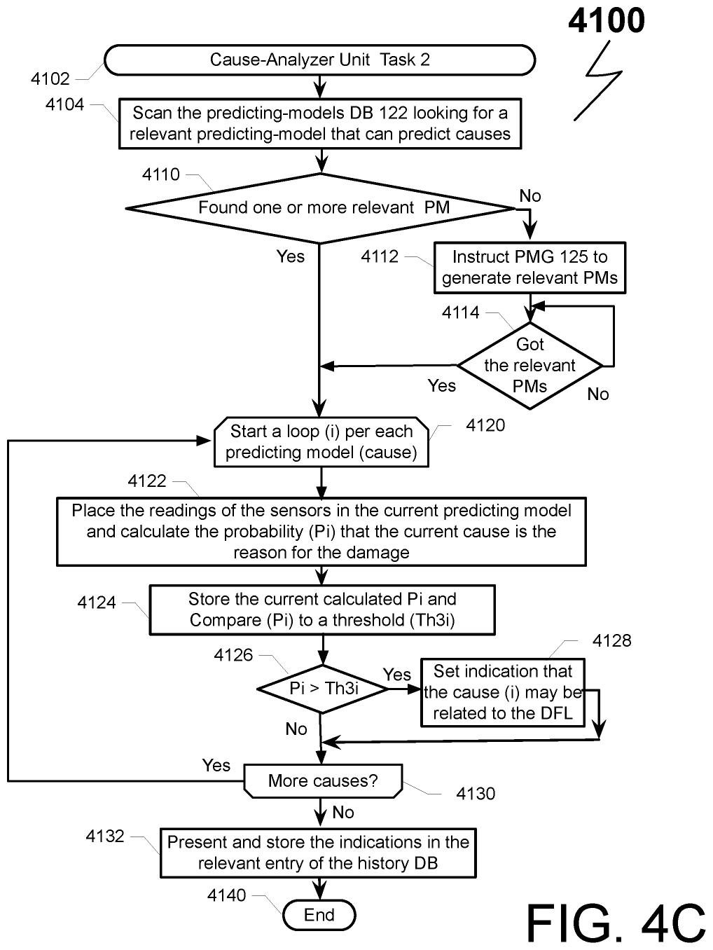

Upon obtaining an appropriate predicting model, DFLAU 126 may calculate the predicted probability for damage and compare it to a certain threshold. The value of the calculated predicted probability points on the likelihood that the DFL is for occurred damages. If the value of the predicted probability is higher than the threshold, then the demand for loss can be marked as a valid DFL, otherwise the DFL can be marked a suspected DFL. Some embodiment of the disclosed technique may select the value of the threshold from a range of 30% to 60%. More information about the operation of DFLAU 126 is disclosed below in conjunction with FIGS. 4A, 4B and 4C (collectively referred to as FIG. 4). Along the disclosure and the claims the terms “the value of the probability” and “the likelihood” can be used interchangeably.

The recommendation of the DFLAU 126 can be added to the SDFLR before transferring the SDFLR to a human surveyor to be used as additional tool while preparing his report. Some example embodiment of DFLAU 126 may use a classifier model instead of a predicting mode. Along the present disclosure the claims the terms predicting mode and classifier model can be used interchangeably.

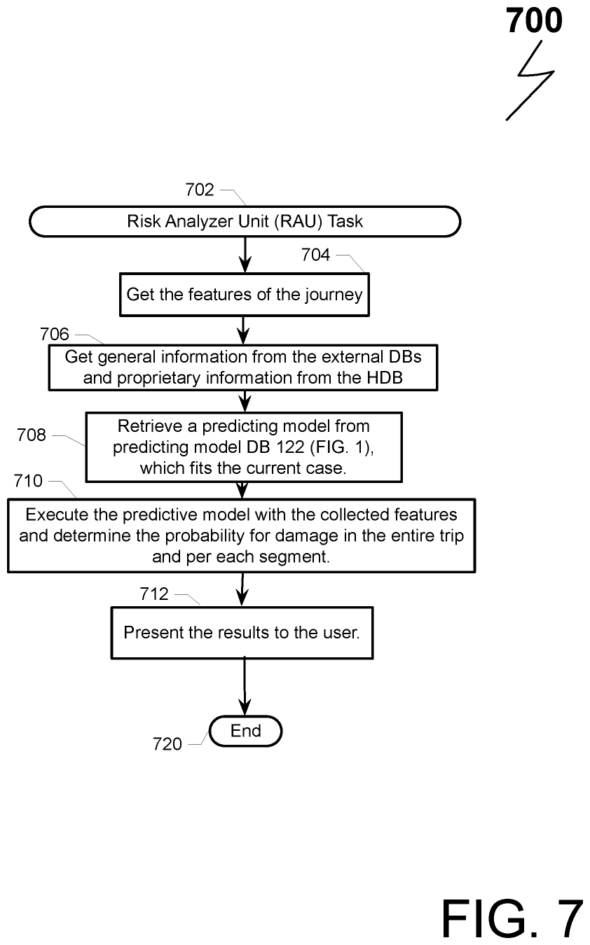

Some example embodiments of the risk analyzing unit (RAU) 127 can be configured to process the stored data in the HDB 123 and deliver one or more predicting models that can be used for predicting the probability for damage along a certain journey for a certain type of cargo at a certain period of the year. In such embodiments the risk analyzer unit (RAU) 127 can associate a risk factor to one or more carriers, one or more types of CSUs, one or more segments, etc. Based on the risk factor or a risk report a shipper can determine via which route to transfer the shipment and by which carrier. In addition the shipping cost can be calculated in view of the risk factor, etc. An example of RAU 127 may be implemented by a processing unit. The processing unit may comprise one or more high-end computers such as but not limited to “Amazon EC2 A1 Instances” or “Amazon EC2 P3 Instances”, which are maintained by Amazon Crop USA, for example. More information about the RAU 127 is disclosed below in conjunction with FIG. 7.

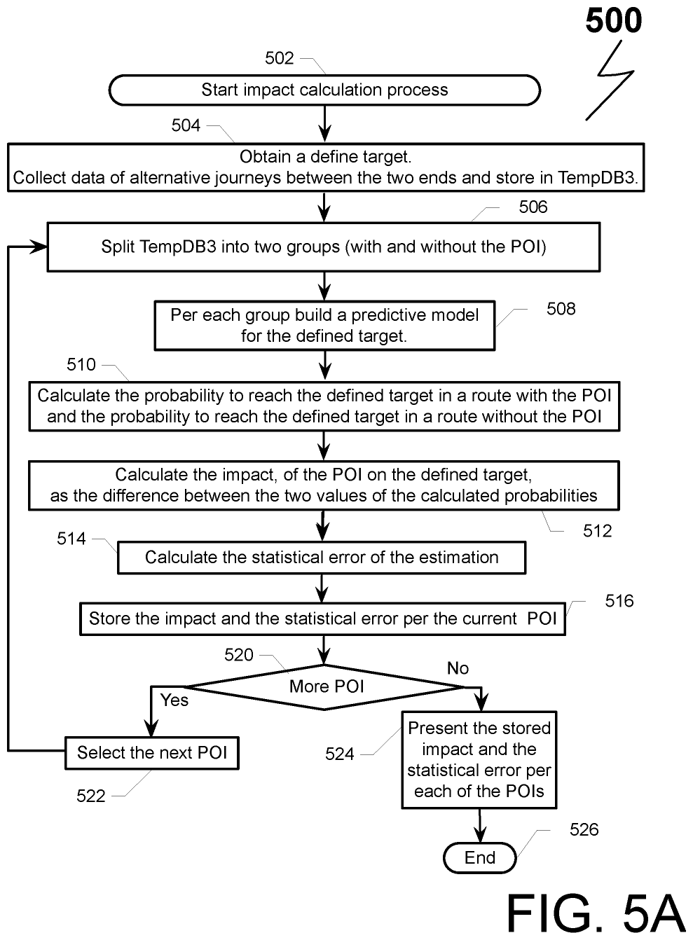

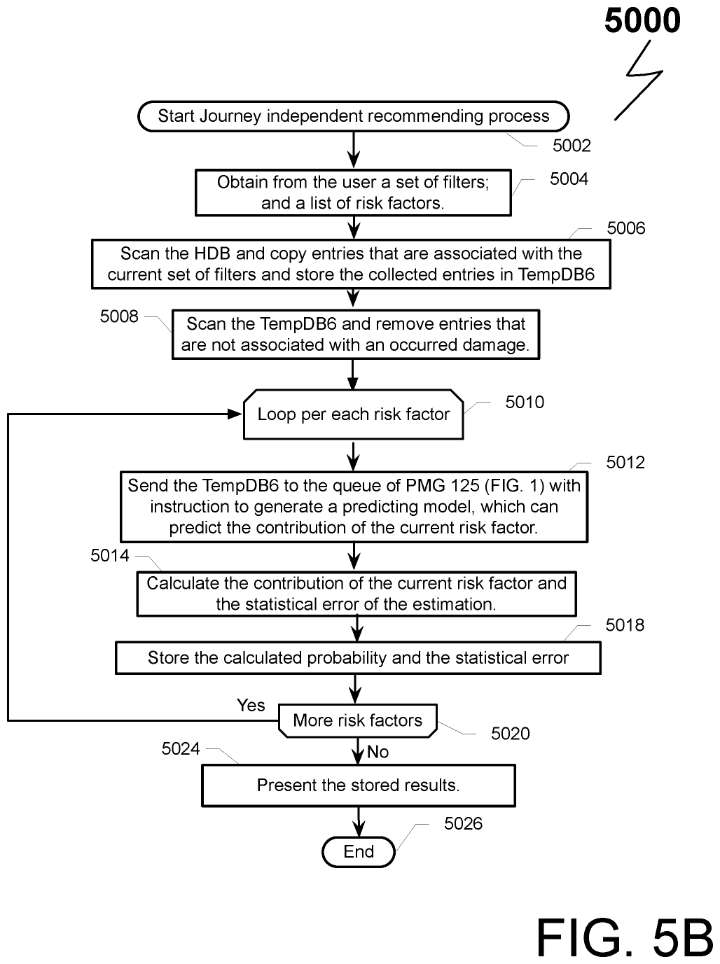

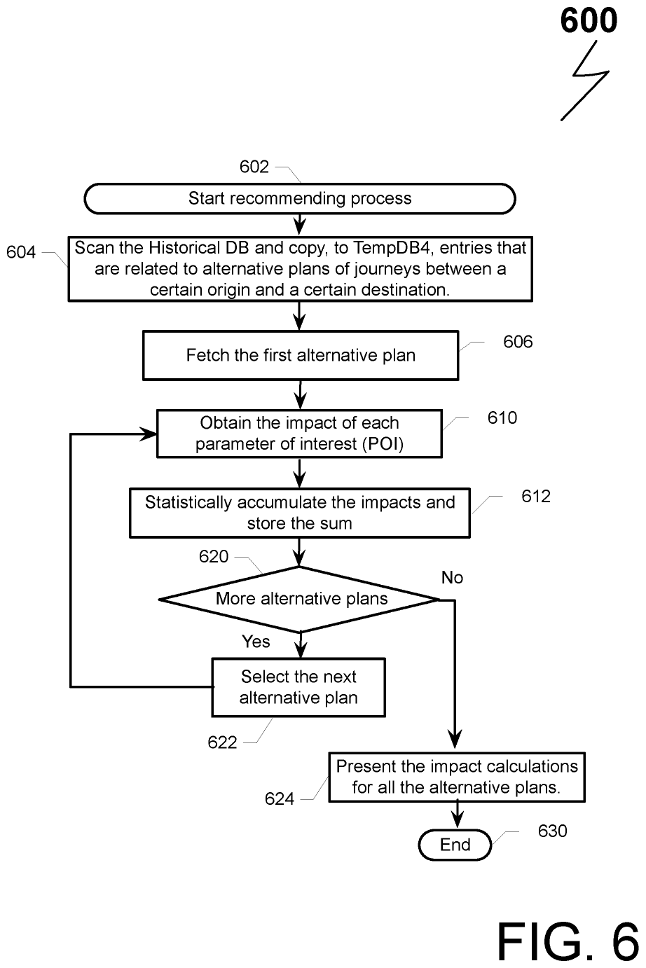

An embodiment of ORU 128 may be configured to deliver operational recommendations based on the data that is stored in the HDB 123. A shipper that needs to deliver a certain cargo from an origin to a destination may deliver to the ORU 128 the type of the cargo, the origin location and destination, the requested date, requested cost, etc. The ORU 128 may process the information in view of relevant journeys that are stored in the HDB 123 and may deliver recommendation how to deliver the relevant cargo with a minimum risk for damage. The recommendations can refer to the type of CSU, the route of the journey, recommended carriers, ports, recommendations where to put the CSU in a ship, etc. An example of ORU 128 may be implemented by a processing unit. The processing unit may comprise one or more high-end computers such as but not limited to “Amazon EC2 A1 Instances” or “Amazon EC2 P3 Instances”, which are maintained by Amazon Crop USA, for example. More information about the operation of examples ORU 128 is disclosed below in conjunction with FIGS. 5A and 5B (collectively FIG. 5) and FIG. 6. In the present disclosure and the claims the terms: memory, a memory device, a storage device, a computer readable device, etc. can be used interchangeably.

Referring now to FIG. 2 that illustrates a flowchart showing relevant actions of method 200. An example of method 200 can be implemented by DFLRU 124 for collecting data of a new case to be stored in a historical database (HDB) 123. Later, the entry can be updated with the decision of the DFLAU 126 about the damage, as it disclosed below in conjunction with FIG. 4 block 436. Method 200 can be initialized 202 after power on, and may run in a loop as long as the DFLRU 124 is active.

After initiation 202 process 200 may wait 210 to obtain a next form of a demand for loss. The form can comprise information such as but not limited to: date, cargo type; origin, destination, number of segments, per each segment: date origin, destination, carrier, loss Y/N; reading of the sensors, the decision of a surveyor that check the demand, the cause of damage, etc. However, similar features of different forms can be expressed in different units. Therefore, the DFLRU 124 may convert 212 the obtained form into an SDFLR.

An example of SDFLR can be a matrix in which the columns can be related to: locations (origin, destination), parameter of interest (POI), segments of the journey, carriers, time, type of CSU, a column per each associated sensor, a column that indicates whether a demand for loss was filed, the value of the demand, the decision of a human surveyor etc. The lines in the matrix can be associated with relevant CSUs. The POI can be the origin, destination, ports along the way, warehouses, cost of journey etc.

Similar parameters (features) in the SDFLR are expressed by the same units. Following are a few examples: the temperature can be presented in Celsius degrees; weight can be presented in Kilogram. Meter per second squared can be used for acceleration, etc. Columns that are associated to missing features can be remained empty

Next, a new entry in the HDB 123 can be allocated 214 by DFLRU 124 and the new SDFLR can be stored 216 in that entry. At block 220 a decision is made whether additional CSU is included in the current form of the DFL. If 220 yes, then process 200 returns to block 212 for handling the next CSU. If 220 there are no additional CSUs, then process 200 may return to block 210 for handling the next demand for loss (DFL) or may wait 210 to obtain a new DFL.

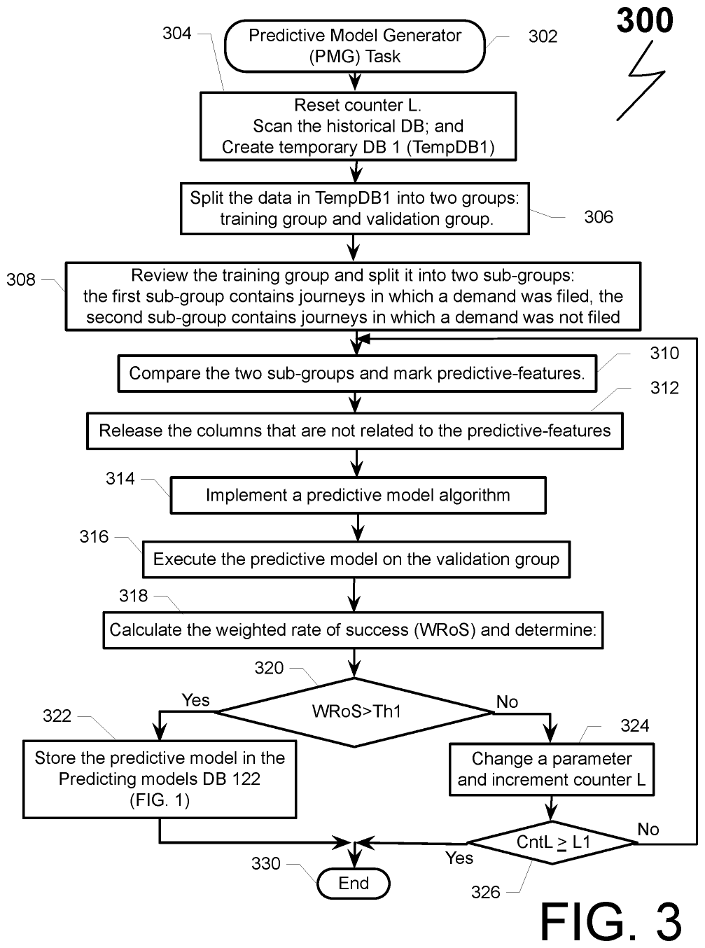

FIG. 3 illustrates a flowchart with relevant processes of an example method 300. Method 300 can be implemented by PMG 125 (FIG. 1) for generating a predictive model. Method 300 can be initialized 302 upon getting a request from DFLAU 126 (FIG. 1), for example. The requested predictive model can be used for predicting the probability that a certain DFL is justified (is valid), for example.

In order to generate a predictive model, an example of PMG 125 (FIG. 1) may search the HDB 123 (FIG. 1) looking for entries that are related to DFLs that were filed for journeys, which is substantially relevant to the journey that is related to the certain DFL, as it is disclosed below in conjunction of block 412 FIG. 4A. A predictive model can be generated taking into consideration the cargo, properties of the journey, of the location on the vehicle, period of the year, etc.

At block 304 method 300 may reset a counter that counts the number of loops that are executed by PMG 126 in order to generate a predictive model. This counter can be referred as counter L (CntL), thus at block 304 the value of CntL is set to zero. Next PMG 126 may scan 304 the HDB 123 (FIG. 1) looking for entries that are related to relevant journeys. The similarity or relevancy can be based on locations, segments, carriers, type of cargo, dates, weather, etc. Those entries are copied 304 to a temporary database 1 (TempDB1).

It should be noted that a person having ordinary skill in that art will appreciate that copy of relevant entries from the HDB 123 (FIG) to a temporary DB can be done by just storing a link for a relevant entry in the HDB in an appropriate entry of the temporary DB.

Next the PMG 125 can split 306 the TempDB1 into two groups, a training group and a validation group. Usually the training group has more entries than the validation group. An example of a training group can have 70% to 99% of the entries of TempDB1. A common training group can have the oldest 90% of the entries of TempDB1.

At block 308 the training group can be divided into two sub-groups. The first sub-group can comprise journeys (entries of TempDB1) in which a DFL was filed. The second sub-group can comprise journeys (entries of TempDB1) in which a DFL was not filed. Next, process 300 may initiate a loop from block 310 to block 326. Each cycle of the loop is used to build a predictive model and checking it.

At block 310 the two sub-groups are compared in order to mark one or more predictive-features. The predictive-features are features (columns in the first sub-group) having values that are substantially dissimilar from the values of the same features in the other sub-group. Features that emphasis the variance between the two sub-groups. Next, the features (columns) that are not marked as predictive-features can be released 312 from the two sub-groups. Examples of predictive-features may comprise temperature and humidity in related CSUs; ranges of acceleration and duration, range of vibration, etc.

At block 314 PMG 125 may execute a predictive model algorithm that process the data in the two sub-groups in order to build a predictive model. Algorithms such as but not limited to logistic regression, linear regression, decision tree, random forest, etc. Then, at block 316 the generated predictive model can be executed on the validation group and the weighted rate of success (WRoS) can be calculated 318. The rate of success can be calculated by counting the number of journeys, from the validation group, in which the predicting model succeeded in predicting that a DFL will be filed divided by the amount of journeys that are included in the validation group. The WRoS takes into consideration the relation between the sizes of each sub-group (the size of the sub-group in which a DFL was filed and the size of the sub-group in which a DFL was not filed).

Next, a decision is made 320 whether the value of WRoS is greater than the value of a first threshold (Th1). Th1 can be a parameter in the range above few tens of percentages, above 40% for example. An example value of Th1 can be 65%. If the WRoS is higher than Th1, then the generated predicting model can be considered as a valid model and be stored 322 in the predicting model DB 122 (FIG. 1) and process 300 can be terminated 330.

If the value of WRoS is smaller or equal to Th1, then the value of one or more parameters can be changed 324. The parameters can comprise the value of Th1, the size of each sub-group the value of L1, etc. In addition, CntL can be incremented 324 by one and a decision can be made 326 whether the value of CntL is greater or equal to a threshold L1. L1 can represent the maximum number of loops that can be implemented in order to define a predicting model. L1 can be in the range of two to five loops for example. A common value of L1 can be 3 times.

If 326 the value of CntL is equal or greater than L1, then process 300 can set an indication that a predicting model cannot be generated for the current case and process 300 can be terminated 330. If the value of CntL is smaller than L1, then process 300 returns to block 310 and execute another cycle of the loop for generating a predicting model.

Before executing the next loop, some embodiments of PMG 125 (FIG. 1) may be configured to change one or more parameters that were used in a previous cycle. Parameters such as but not limited to the value of TH1 or L1, for example. Some embodiment of process 300 may modify the criteria for defining 310 a feature as a predictive-feature. An example embodiment of process 300 may reduce the amount of dissimilarity of a certain feature in order to increase the number of predictive-features, etc.

In cases in which a certain predicting model fit two or more types of cargo, then at block 312 features, which can be used for both types, can be marked as interactive features or compound features. In an alternate example embodiment of process 300, at end of block 326, the PMG creates L1 predictive models. In such embodiments, the L1 predictive models can be ensemble into a single predictive model which is a weighted average of the L1 models.

FIG. 4A illustrates a flowchart with relevant processes of an example of method 400. An example of method 400 can be implemented by DFLAU 126 (FIG. 1) for analyzing whether a DFL that is related to a certain CSU is justified (valid), for example. Method 400 can be initialized 402 by DFLAU 126 (FIG. 1) upon receiving a new SDFLR.

After initiation, process 400 may scan 404 the Predicting-Models DB 122 (FIG. 1) looking for a relevant predicting model. The relevant predicting model can predict the probability (likelihood) that the new SDFLR is valid. The relevancy or can be based on the type of cargo, segments, carriers, locations, dates, weather, type of CSU, etc. of the related journey. If 410 a relevant predicting model may not found in the Predicting-Models DB 122 (FIG. 1), then DFLAU 126 may instruct 412 PMG 125 (FIG. 1) to generate a relevant predicting model that can be used for the entire journey (Pe).

Next, DFLAU 126 may wait 414 to obtain the relevant predicting model. Upon obtaining the relevant predicting model DFLAU 126 may proceed to block 416 for calculating and storing the value of the probability (Pe) that the relevant SDFLR is valid. The calculated Pe is related to the entire journey. The calculated probability can point on the likelihood that the DFL is a valid DFL.

Returning now to block 410, if a relevant predicting model was found in Predicting-Models DB 122 (FIG. 1), then process 400 may proceed to block 416 for calculating and storing the value of Pe and process 400 may proceed to block 420. At block 420 a decision is made whether the calculated value of Pe is greater than a threshold TH2. If 420 the value of Pe is not greater than TH2, then an indication that the relevant DFL is suspected can be added 422 to the relevant SDFLR and DFLAU can proceed to block 442. The value of TH2 can be few tens of percentages. An example range of values for TH2 can be between 20%-60%. A common value for Pe can be 40%, for example.

If 420 the value of Pe is greater than TH2, then an indication that the relevant DFL is valid can be added 424 to the SDFLR and DFLAU 126 (FIG. 1) can proceed to block 430 looking for one or more segments to which the current DFL can be associated.

Based on the assumption that damage to a certain type of cargo depends mostly on the type of the cargo some embodiments of DFLAU 126 (FIG. 1) may use the same predicting model (Pe) for predicting the probability that a DFL will be filed per a segment of that journey. Other example embodiments of DFLAU 126 (FIG. 1) may ask PMG 125 (FIG. 1) to deliver a predictive model that can predict the probability that a Demand for Loss (DFL) will be submitted at the end of a certain segment (i), Pi for segment (i) of the journey.

In some cases, the segments can be identified based on data from the Journey DB 111 (FIG. 1). In other cases the DFLAU 126 (FIG. 1) can be configured to define the segments based on the reading from a timing sensor that is associated with that CSU, other embodiments of DFLAU 126 can be configured to define the segments based on analyzing the readings of the sensors and compare them to an index that associate reading of different sensors to a certain type of carrier. Each type of carrier can be associated with unique range of vibration, acceleration, shocks, etc.

At block 430 a loop can be initiated between blocks 430 to 440. Each cycle of the loop (i) can be associated with one of the segments (segment i). At block 432 reading of the sensors that are related to the relevant segment are retrieved and are placed 432 in the relevant predicting model. The probability (Pi) that a DFL may be filed at the end of that segment is calculated 432 and be stored 434 as Pi in a table. Then the value of Pi can be compared to a threshold TH2i. In some embodiments TH2i can have the same value of TH2.

At block 436 a decision is made whether the value of Pi is greater than the value of TH2i. If 436 the value of Pi is not greater than the value of TH2i, then a decision is made 440 whether there is an additional segment. If 440 yes, then process 400 returns to block 430 for calculating the Pi of the next segment. If 440 there are no additional segments, then process 400 proceeds to block 442.

If at block 436 a decision is made that the calculated Pi is higher than the value of the relevant threshold Th2i. If 436 yes, then an indication that the relevant segment (i) can be associated with the current DFL and process 400 may proceed to block 440. In some embodiments, the indication can be added to the standardized-demand-for-loss-report (SDFLR) before transferring the SDFLR to a human surveyor. The indication whether the DFL is valid or not can be used by the human surveyor as an additional tool.

At block 442 the indications whether a filed DFL is valid and the relevant one or more segments can be presented 442 to the user and be stored in the history DB 123 and process 400 can be terminated 450.

FIG. 4B schematically illustrates a flowchart showing relevant actions of a causes-analyzer-task 4000. The causes-analyzer-task 4000 engages PMG 125 (FIG. 1) and DFLAU 126. The PMG 125 (FIG. 1) can generate a predicting model that can predict one or more causes for certain damage while the DFLAU 126 (FIG. 1) can be configured to implement the generated model in order to identify the cause for the damage. Other example embodiments of the disclosed technique may use two separated processes. The first one can be a process for creating a predicting model per each cause and the second process can be implemented for pointing on suspected reasons for the damage.

After initiation 4002, process 4000 may scan 4004 the HDB 123 (FIG. 1) looking for entries that are related to journeys in which a DFL was filed and the entry also includes indication about the cause for that damage. Those entries are copied 4004 to a temporary database 5 (TempDB5) and a list of causes for damages can be created.

The TempDB5 and the list can be transferred toward PMG 125 with an instruction 4006 to generate a predicting model or a classifier model per each cause from a group of reasons (causes) for damages. Upon getting the plurality of predicting models (one per each possible cause) a loop between block 4010 to 4040 can be initiated. Each cycle (k) of the loop can be associated with a suspected cause for the damage.

At block 4012 readings of the sensors and other parameters that are related to the current demand for loss are placed in the predicting model that is related to the current cause (k) and the probability that the damage was generated by the current cause is calculated 4012 and be stored 4014 as Pk in a table. In other words, the value of the calculated probability (Pk) indicates the likelihood that the cause (k) is one of the reasons for the damage.

Next the value of Pk is compared 4022 to a threshold TH3. Some embodiments of the disclosed technique may use a plurality of thresholds, one for each Pk. The different values can depend on the type of cause, on the type of cargo, etc. TH3 can be in the range of 10-60%, for example. A common value of TH3 can be 30%, for example.

If 4030 the value of Pk is greater than Th3, then in block 4034 an indication can be set that the cause (k) is a suspected reason for the damage. If 4030 the value of Pk is smaller than Th3, then in block 4032 an indication can be set that the cause (k) is not a suspected reason for the damage. Next, a decision is made 4040 whether there is an additional suspected cause. If yes, process 4000 returns to block 4010 and executes the next cycle of the loop.

If 4040 there are no additional causes, then at block 4042 the indications about the possible causes can be stored 4042 in the relevant entry of the HDB 123 (FIG. 1) and a report can be delivered 4042 to the user. Then process 4000 can be terminated 4050.

In some example embodiments of the disclosed technique, process 4000 can be modified to include three or more indications. Indications such as but not limited to: a suspected cause, almost a suspected cause, most likely suspected cause, etc.

FIG. 4C illustrates a flowchart with relevant processes of another example of a method 4100 that can be used to point on one or more possible causes for the damage of a valid DFL. An example of method 4100 can be implemented by an example of DFLAU 126 (FIG. 1). Method 4100 can be initialized 4102 by DFLAU 126 (FIG. 1) upon receiving a new SDFLR.

After initiation 4102, process 4100 may scan 4104 the Predicting-Models DB 122 (FIG. 1) looking for one or more relevant predicting models. The relevant predicting model can predict the probability that a certain cause is a suspected one. The relevancy or similarity can be based on the type of the cargo, dates, weather, type of CSU, etc. If 4110 a relevant predicting model cannot be found in the Predicting-Models DB 122 (FIG. 1), then PMG 125 (FIG. 1) can be instructed 4112 to generate one or more predicting models. Each predicting model can be used to predict the probability that the current cause can be one of the reasons for the relevant damage, a possible cause.

Next, process 4100 may wait 4114 to obtain the relevant one or more predicting models. Upon obtaining 4114 the relevant predicting model process 4100 may proceed to block 4120 and initiate a loop between block 4120 and block 4130. Each cycle of the loop (i) can be associated with one of the possible causes (i). At block 4122 reading of the sensors are retrieved and be placed 4112 in the current predicting model (i). The probability (Pi) that the current cause can be a reason for the damage is calculated 4112 and be stored 4124 as Pi in a table. In addition the value of Pi can be compared to the value of a threshold TH3i. In some embodiments TH3i can have the same value for all possible causes.

At block 4126 a decision is made whether the value of Pi is greater than the value of TH3i. If the value is greater, then an indication is set 4128 that cause (i) may be related to the valid DFL. Thus, that cause (i) can be one of the reasons for the damage which is indicated in the current DFL. And process 4100 proceeds to block 4130. In other words, the value of the calculated probability (Pi) indicates the likelihood that the cause (i) is one of the reasons for the damage.

If 4126 the value of Pi is not greater than the value of TH3i, then a decision is made 4130 whether there are additional possible causes. If yes then process 4100 returns to block 4120 and start a new cycle.

If 4130 there are no additional causes, then process 4100 proceed to block 4132 and the indications about possible one or more causes can be presented 4132 to the user and be stored in the history DB 123. Next process 4100 can be terminated 4140.

Referring now to FIG. 5A that illustrates a flowchart showing relevant processes that can be used by method 500. Method 500 can be implemented by an example of operational-recommending-unit (ORU) 128 (FIG. 1) for calculating the impact of each Parameter-Of-Interest (POI) on a journey. The POIs could be locations along alternative routes between the origin and the destination, cost of the journey for the carrier, duration of the journey, etc.

Method 500 can be implemented per a defined target. The defined target can be values of one or more features, which are critical to the condition of the cargo. For example, the range of temperatures, acceleration above a certain threshold, vibration (amplitude and frequency), cost, etc. In addition, the defined target can be the cost of journey for the carrier, the duration of the journey, etc.

Process 500 can be initiated 502 by obtaining a request from a user, for example, to get a recommendation for a route from an original to a destination. The user may define the target that is relevant for that cargo and a list of one or more risk factors that are relevant for the recommendation. The user can be a shipper, a consignee, a carrier, etc.

At block 504 the defined target is obtained and process 500 may scan the historical DB 123 (FIG. 1) looking for entries that are related to alternative journeys between the relevant two ends (the origin and the destination of that journey). Those entries can be copied to a temporary database 3 (TempDB3). Then a loop can be initiated between block 506 to block 520. Each cycle in the loop can be associated with a POI.

At block 506 the data of TempDB3 can be divided into two groups. The first group contains journeys that include the current POI and the second group contains journeys that do not comprise the current POI.

Next, a predictive model can be generated 508 per each group and per each defined target. One predictive model can predict the probability that the defined target can be reached in a journey with that POI and the other predictive model can predict the probability that the define target can be reach in an alternative journey without that POI.

At block 510 the probability to reach the defined target with the current POI can be calculated using the appropriate generated predictive model. In addition, the probability to reach the defined target in a route without the current POI can be calculated 510 by using the other generated predictive model.

The impact of the current POI on the define target can be calculated 512 as the difference between the two values of the probabilities that were calculated in block 510. At block 514 the statistical error of the estimation can be calculated. Some example embodiments of the disclosed technique may use standard deviation as the statistical error. Other embodiments may use other type of statistical error. The impact and the statistical error that related to the current POI can be stored 516 in a computer readable memory device that is associated with ORU 128 (FIG. 1). An example of computer readable memory device can be a read/write hard disc, CDROM, Flash memory, ROM, or other memory or storage devices.

Next, a decision is made 520 whether additional POI exists. If 520 there is additional POI, then the next POI is selected 522 and process 500 returns to block 506 for calculating the impact of the next POI. If 520 there is no additional POI, then process 500 may present 524 the stored calculated impacts and the statistical errors that were calculated per each POI.

The presentation can be executed as a table in which the rows represent alternative journeys between the original and the destination and each column represents a POI along that journey. The impact and the statistical error can be written in the appropriate cells of that table. The table can be printed or displayed 524 to the user and process 500 can be terminated 526.

FIG. 5B schematically illustrates a flowchart of method 5000 that can be implemented by an example of operational-recommending-unit (ORU) 128 (FIG. 1). Method 5000 can be executed per a define set of filters and per a list of one or more of risk factors. The set of filters may comprise of a combination of type of cargo, location, season of the year, a type of CSU, etc. The list of risk factors can comprise a plurality of possible risks. An example of a list can comprise: temperature above 50 Celsius degrees for at least 30 min; acceleration above 8 g, humidity above 70%, etc.

Process 5000 can be initiated 5002 by obtaining a request from a user, for example, to get a recommendation for handling a certain cargo. The user may define 5004 the relevant set of filters and the list of risk factors. The user can be a shipper, a consignee, a carrier, etc.

At block 5006 the HDB 123 (FIG. 1) can be scanned and entries that are associated with the defined set of filters can be copied to a temporary DB 6 (TempDB6). In some embodiments a link per each entry of those entries can be copied to TempDB6. At block 5008 the TempDB6 can be scanned and entries that are not associated with occurred damages can be removed from TempDB6.

Next a loop between block 5010 and 5020 can be initiated. Each cycle of the loop can be associated with a certain risk factor from the obtained list of risk factors. At block 5012 the TempDB6 can be transferred toward a queue of PMG 125 (FIG. 1) with a request to generate a predicting model that can predict the contribution of the current risk factor to the occurred damage.

Upon obtaining the requested predicting model from PMG 125, the contribution of the current risk factor and the statistical error of the estimation can be calculated 5014. The calculated probability and the statistical error can be stored 5018 in a memory device that is associated with ORU 128 (FIG. 1). Next a decision is made 5020 whether additional risk factors are included in the list of risk factors. If 5020 yes, then process 5000 returns to block 5010 for handling the next risk factor. If 5020 not, then the stored results can be presented 5024 to the user.

Some example embodiments may use 5024 a table in which each row is associated with a define set of filters and each column is associated with a risk factor. Thus, each cell of the table can present 5024 the calculated probability to reach the relevant risk factor for the relevant set of filters as well as the associated statistical error. After presenting the results process 5000 can be terminated 5026.

Referring now to FIG. 6 that illustrates a flowchart showing relevant actions of an example of recommending process 600. Method 600 can be implemented by an example of operational-recommending-unit (ORU) 128 (FIG. 1) for calculating the impact of each alternative routes between an original place and a destination. Method 600 can be initiated 602 by ORU 128 (FIG. 1) and be executed per a defined journey.

At block 604 the historical DB 123 (FIG. 1) can be scanned looking for entries that are related to alternative plans for a journey between the origin and the destination of the relevant journey. A plan of a journey can comprise of the points of origin and destination, the loading plan of the CSU, the duration of stops at each port, costs of the journey for the carrier, etc. Those entries can be copied 604 to a temporary database 4 (TempDB4).

Next, the first alternative plan can be fetched 606 from TempDB4 and the impact of each one of POIs along this route can be obtained 610 from the data that was stored by method 500 as it is disclosed above in conjunction with block 516 (FIG. 5A). Along the present disclosure and the claims the terms route of a journey and a plan of a journey can be used interchangeably.

Next, the obtained 610 impacts of each of the POI along the current alternative plan is statistically accumulated as random variables 612 and the sum can be stored 612 in a table. Each row of the table can be associated with an alternative plan and the column can be associated with the sum of impacts. At block 620 a decision is made whether additional alternative plans exist in TempDB4. If 620 there is an additional alternative plan, then process 600 may select 622 the next alternative route and returns to block 610 for handling the impact of the next alternative route.

If 620 there are no alternative plans, then process 600 may present 624 the stored calculated impacts of each one of the alternative plans. The presentation 624 can be implemented by a table in which the rows represent alternative plans of a journey between the original and the destination. Each column can present the impact that is associated with that plan. The table can be printed or displayed 624 to the user and process 600 can be terminated 630.

FIG. 7 schematically illustrates a flowchart showing relevant processes that can be implemented an example embodiment of method 700. Method 700 can be initiated 702 by an example of a risk-analyzer unit (RAU) 127 (FIG. 1) for determining the risk that is involved in a certain journey for a certain type of cargo. At block 704 method 700 may lead the user to load the RAU 127 with the features of the journey. The features of the journey may comprise cargo information, the locations of the original and destination, carriers, period of the year, etc. The cargo information may comprise sensitivity to shocks, sensitivity to vibrations (amplitude and frequency), sensitivity to temperature, sensitivity to humidity, sensitivity to water, etc.

Next, information, which is relevant to the certain journey and the certain cargo, can be obtained 706 from the external DBs (DB 111 to DB 118 of FIG. 1). The information can comprise information about the weather, possible storms, the type of CSU, etc. In addition common readings from the relevant one or more sensors (sensors similar to the sensors that are associated with the current CSU) can be retrieved 706 from the historical DB 123 (FIG. 1).

At block 708 a predicting model for predicting whether a loss is likely to be demand, can be fetched from predicting model DB 122. The fetched predicting model was generated for a relevant journey and relevant type of cargo. The similarity or relevancy can be based on type of cargo, segments, carriers, locations, dates, weather, etc. Next the collected features that were obtained in blocks 704 and 706 can be placed in the fetched predictive model in order to calculate 710 the probability for damage in the entire journey and per each of the relevant segments. The value of the calculated probability points on the likelihood that a damage may be occurred.

Then, the results can be presented 712 by a table in which the first row represent the entire journey and the following rows represent one or more segments of that journey. The column represents the calculated risk. Thus, each cell in the table stores the risk that is associated with the relevant location. The table can be printed or displayed 712 to the user and process 700 can be terminated 720.

In the description and claims of the present disclosure each of the verbs: “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons having ordinary skill in the art that the present invention is not limited by what has been particularly shown and described herein above. Rather the scope of the invention is defined by the claims that follow.

What is claimed is:

1. A computer readable memory device comprising executable instructions that when executed cause a processor, at a risk-analyzer-unit (RAU):
i. to obtain one or more features of a journey of cargo that is carried in a cargo-shipping-unit (CSU);
ii. to obtain a predictive model that is related to the journey and is configured to predict the likelihood that a demand for loss (DFL) will be filed;
iii. to execute the predictive model taking into consideration the obtained one or more features; and
iv. to present the likelihood that a demand for loss (DFL) will be filed as the risk that is involved in the journey.

2. The computer readable memory device of claim 1, wherein executable instructions further comprising an instruction when execute causes the RAU to obtain general information that is relevant to the journey.

3. The computer readable memory device of claim 1, wherein the one or more features of the journey comprise at least one feature of the cargo.

4. The computer readable memory device of claim 1, wherein the one or more features of the cargo comprise the sensitivity of the cargo to shocks.

5. The computer readable memory device of claim 1, wherein the one or more features of the journey comprise weather information.

6. The computer readable memory device of claim 1, wherein the one or more features of a journey comprise information related to the CSU.

7. The computer readable memory device of claim 1, wherein the journey comprises one or more segments and the risk is calculated per a segment of the journey.

8. The computer readable memory device of claim 7, wherein the segment of the journey is implemented by a vehicle.

9. A system comprising:
a. a risk-analyzer-unit (RAU) that is communicatively coupled with one or more databases (DBs); and
b. wherein the RAU is a processor that is configured:
i. to obtain one or more features of a journey of cargo that is carried in a cargo-shipping-unit (CSU), wherein the journey comprises one or more segments;
ii. to obtain a predictive model that is related to the journey and is configured to predict the likelihood that a demand for loss (DFL) will be filed;
iii. to execute the predictive model taking into consideration the obtained one or more features; and
iv. to present the likelihood that a demand for loss (DFL) will be filed as the risk that is involved in the journey.

10. The system of claim 9, wherein the RAU is configured to obtain general information that is relevant to the journey.

11. The system of claim 9, wherein the one or more features of the journey comprise at least one feature of the cargo.

12. The system of claim 9, wherein the at least one feature of the cargo comprises the sensitivity of the cargo to shocks.

13. The system of claim 9, wherein the one or more features of the journey comprise weather information.

14. The system of claim 9, wherein the one or more features of the journey comprise information related to CSU that is used for storing the cargo during the journey.

15. The system of claim 9, wherein the risk is calculated per a segment of the journey from the at least one segments.

16. The system of claim 15, wherein the segment of the journey is implemented by a vehicle.
